(19) United States
(12) Patent Application Publication
(10) Pub. No.: US 2008/0299281 A1
(43) Pub. Date: Dec. 4, 2008

(54) Emulsifiers and Emulsions

(76) Inventor: Jacobus Johannes Burger, Lelystad (NL)

Correspondence Address: JONES DAY, 222 EAST 41ST ST, NEW YORK, NY, 10017, US

(21) Appl. No.: 11/884,869

(22) PCT Filed: Feb. 9, 2006
(86) PCT No.: PCT/GB2006/000460

§ 371 Date: May 19, 2008

(30) Foreign Application Priority Data
Feb. 23, 2005 (GB) 0503684.3

(51) Int. Cl. A23L 1/035; B01F 3/08; B01F 17/30; A23D 7/00; A23L 2/38

(52) U.S. Cl. 426/590; 426/654; 426/602

(57) ABSTRACT

An emulsifier which is a protein/polysaccharide conjugate derived from whey protein and a non-ionic polysaccharide, more particularly dextran, maltodextrin or gum Arabic, is described together with its application in emulsions and beverages.

The invention relates to emulsifiers and emulsions and, in particular, to whey protein emulsifiers and to foodstuff and/or beverage emulsions containing such emulsifiers.

Emulsifiers are used to generate stable emulsions in a wide range of applications. One field in which emulsions find particular utility is the food and drinks industry wherein they are used inter alia to disperse organoleptic ingredients within foodstuffs and beverages. As many organoleptic ingredients (flavours and fragrances) are oils, it is necessary to create emulsions, usually oil-in-water emulsions, to ensure the oil is well dispersed throughout the foodstuff or beverage.

Although there are many emulsifiers that will enable stable emulsions of oil-in-water to be generated, clearly there is a relatively limited range of such emulsifiers that are permitted to be used in the food and drinks industry. The requirements for such emulsifiers are that they are biologically acceptable and safe for human consumption; they create emulsions in which the dispersed phase is present in fine droplets; and they maintain the stability of the emulsions, ie the droplet sizes do not increase significantly nor do droplets aggregate together, for reasonable periods of time. Frequently, the emulsifiers also have to function effectively in the presence of other additives such as colourants, preservatives, acidulants, thickening agents, sucrose etc. In many food and drink applications, it is also necessary to take into account such factors as appearance, texture, palatability and mouthfeel.

Many emulsifiers used in the food and drinks industry are biomolecular in origin and are typically proteins and polysaccharides. Typical emulsifiers include gum Arabic, whey proteins, casein, lactoglobulin, albumin, ovalbumin, pectins, soy protein and pea protein and polysaccharides and mixtures of proteins and polysaccharides. Examples of such emulsifiers are described in Chapter 3 entitled “Natural Colloids as food emulsifiers”, Garti et al of “Design and Selection of Performance Surfactants”, Annual Surfactants Review, Vol 2, Ed D R Karsa (1999), ISBN 1-85075-993-6 and “What can nature offer from an emulsifier point of view: trends and progress?, Garti, Colloids and Surfaces, A: Physiochemical and Engineering Aspects 152 (1999) 1225-146”. Gum Arabic, which is a mixture of glycoproteins and polysaccharides, has, in particular, been very widely used in the food and drinks industry. However, it is frequently necessary to use relatively high quantities, eg up to 20 to 30 wt %, of gum Arabic to obtain the required emulsifier effect.

Many proteins are also not particularly effective emulsifiers at or near their isoelectric points, which are usually at a pH of less than 7, and are typically approximately 4.5. Given that many foodstuff and beverage applications, particularly for example fruit flavoured drinks, are acidic in nature, ie they typically have a pH of about 3.5, this places proteins at a disadvantage as emulsifiers in such applications. Other disadvantages of using proteins as emulsifiers include the non-compatibility of proteins with charged polysaccharides such as xanthan and with synthetic colouring agents of the azo type.

There have been proposals to use protein/polysaccharide conjugates obtained by dry heating mixtures of proteins and polysaccharides. This treatment causes the amine groups in the protein to link with the reducing end carbonyl groups of the polysaccharide. This linkage of groups is known as an Amadori rearrangement step that occurs during the Maillard reaction, ie browning, that takes place when foodstuffs are dry heated. Examples of such protein/polysaccharide conjugates are described in “Emulsion stabilization by ionic and covalent complexes of β-lactoglobulin with polysaccharides”, Dickinson et al, Food Hydrocolloids 5 (1991) No 3 281-296 and “Dairy glycoconjugate emulsifiers: casein—maltodextrins”, Shepherd et al, Food Hydrocolloids 14 (2000) 281-286.

However, although such synthesised protein/polysaccharide conjugates have been known for some time now, as far as the Applicant is aware, none are in general use.

Notwithstanding this situation, the Applicants have found certain protein/polysaccharide conjugates to have particular utility as emulsifiers and are able to replace gum Arabic per se in at least some applications and are effective in significantly lower quantities.

According to the present invention, an emulsifier comprises a protein/polysaccharide conjugate derived from whey protein and a non-ionic polysaccharide.

In a particularly preferred embodiment of the invention, an emulsifier comprises a protein/polysaccharide conjugate derived from whey protein and a polysaccharide component selected from the group consisting of a dextran or a maltodextrin or a polysaccharide group contained in a naturally occurring gum, preferably gum Arabic, or mixtures thereof.

Preferably, the weight ratio of protein to polysaccharide in the conjugate is in the range 1:0.9 to 1:10. More preferably, the protein to polysaccharide weight ratio is at least 1:1 and, more especially, is at least 1:2 and is not more than 1:8 and, more especially, is not more than 1:6.

Preferably, the whey protein is lactose-free whey protein; more especially the whey protein is a lactose-free whey protein isolate.

Preferably the non-ionic polysaccharide is a dextran or a maltodextrin or a polysaccharide unit contained in a naturally occurring gum, preferably gum Arabic.

More preferably, the non-ionic polysaccharide is a maltodextrin. Preferably, the maltodextrin is selected to have a dextrose equivalent (DE) of between 5 and 50. More preferably, the maltodextrin is selected to have a DE of at least 10 and, more especially of at least 12. More preferably, the maltodextrin is selected to have a DE of less than 40, more especially of less than 30. Preferred maltodextrins for use in the invention have a DE of between 15 and 25 and particularly of about 20.

With regard to gums, and in particular to gum Arabic, they tend to be complex, large molecules that may, for example, contain acid groups or acid residues. Accordingly, such gums may be considered to exhibit weak anionic character. However, the gums, particularly gum Arabic, include polysaccharide units that are non-ionic in character and have reducing end carbonyl groups that may be utilised in accordance with the invention to form conjugates with whey protein.

The present invention also includes a process of making an emulsifier comprising a protein/polysaccharide conjugate derived from whey protein and a non-ionic polysaccharide, the process comprising intimately mixing the whey protein and the polysaccharide, exposing the mixture to dry heat under controlled humidity conditions for a period sufficient to allow at least a major proportion of the protein's amine groups to form covalent linkages with the polysaccharide.

It will be appreciated the protein/polysaccharide conjugates of the present invention may be prepared by any convenient methods. For example, the initial mixing of the whey protein and non-ionic polysaccharide may be achieved by simple mixing of the ingredients; spray drying a solution of the whey protein and non-ionic polysaccharide; or extruding a mixture of the whey protein and non-ionic polysaccharide through an extruder fitted with a static pipe mixer. Provided the relevant temperature and relative humidity are controlled, the dry heating step may be achieved using any suitable heating means. For example, an oven may be used; or a continuous process using a belt conveyor/heater combination; or fluid bed equipment.

The present invention includes the use of an emulsifier according to the invention in an emulsion.

The present invention also includes an oil-in-water emulsion comprising water, an organoleptic oil and an emulsifier according to the invention. Preferably, the emulsion comprises 70 to 95 wt % of an aqueous phase and 5 to 30 wt % of a dispersed phase. Preferably, the emulsion comprises 0.1 wt % to 10 wt % emulsifier. More preferably, the emulsion comprises at least 1 wt % of emulsifier. More preferably, the emulsion comprises not more than 7 wt % of emulsifier, more especially, not more than 5 wt % emulsifier. The weight percentages are relative to the total weight of the emulsion.

Preferably, the emulsion has a pH of not greater than 7. More preferably, the emulsion is acidic, ie it has a pH in the range 2 to 6, more preferably in the range 3 to 5.

Emulsions according to the invention may also contain other emulsifiers such as sodium acetate isobutyrate (SAIB), ester gum, dammar gum; flavour oils such as orange or other citrus fruit oils; fragrance ingredients etc.

The present invention also includes a beverage comprising a diluted emulsion according to the present invention. Preferably, the beverage contains at least about 1 part of emulsion in 100 parts of beverage and, more preferably, contains at least 1 part of emulsion in 250 parts of beverage and, more especially, contains at least about 1 part of emulsion in 400 parts of beverage. Preferably, the beverage contains not more than about 1 part of emulsion in 1000 parts of beverage and, more preferably, contains not more than about 1 part of emulsion in 750 parts of beverage and, more preferably, contains not more than about 1 part of emulsion in 600 parts of beverage. The beverage preferably contains about 1 part of emulsion in 500 parts of beverage.

The diluent is preferably water which, optionally, may also be carbonated and, optionally, may contain other ingredients, for example citric or other acids, sucrose, artificial sweeteners, colouring agents, flavouring materials etc.

The invention will now be illustrated with reference to the following Examples.

The following materials were used in the Examples:
1. Whey Protein Isolate (“WP”), available under the trade name BiPro (WP) from Davisco Food International. The product is a homogenous, semi-hygroscopic powder, is lactose-free and has an isoelectric pH of 4.7.
2. Pea Protein Isolate (“PP”), available under the trade name Pisane HD, from Westwood International (Cheshire, UK). The pea protein is a natural ingredient extracted from the yellow pea (pisum sativum) and has an isoelectric pH of 4.5.
3. Sodium caseinate (“SC”) (5.2 wt % moisture, 0.05 wt % calcium, isoelectric pH 6) from de Melkindustrie (Netherlands).
4. Proform 781 soy protein (isoelectric pH ˜5) from ADM.
5. Medium-Chain Triglyceride oil (MCT oil) from Quest International.
6. Orange oil from Quest International.
7. n-Tetradecane from Sigma Chemicals (UK).
8. Silicone oil (Dow Corning 200/20cS fluid, Lot 061601).
9. Sodium lactate solution (about 50%, Lot K24888657) was purchased from BDH Laboratory Supplies.
10. Polysaccharide dextran (“DX”) (average molecular weights of 70, 245, 500 kDa) and β-lactoglobulin from bovine milk (approx. 90%) were purchased from Sigma Chemicals. The samples containing DX are also identified by the molecular weight used, eg DX70, DX 245 and DX500.
11. Polysaccharide maltodextrin (“MD”) (DE=2, Mw=280 kDa; DE=19, Mw=8.7 kDa; DE=47, Mw=2 kDa) from Roquette (UK) Limited.
12. Gum Arabic (“GA”) (which is a mixture of glycoprotein and non-ionic polysaccharides) from Colloides Natureis International (France).

In the Examples, the protein/polysaccharide conjugates were prepared by dissolving the protein and polysaccharide in distilled water in selected weight ratios. The samples were then freeze-dried to remove the water, and were ground to make the powder. A desiccator was placed in the oven at 80° C. for 10-15 minutes to achieve the equilibrium temperature. A sample was placed in the desiccator at 80° C. for two hours during which the Amadori rearrangement took place. The desiccator had a saturated KBr solution in the bottom of it to maintain a relative humidity of 79%. The resultant conjugate had a light brownish colour apparently due to non-enzymatic browning.

References in the Examples to heat treated protein refer to subjecting the protein to the heat treatment described in the preceding paragraph.

In the Examples, emulsion droplet size distributions were measured using a Malvern Mastersizer MS2000 static laser light-scattering analyser with absorption parameter value of 0.001. The average droplet size was characterised by two mean diameters, d₃₂ and d₄₃ defined by:

d₃₂=Σᵢnₗdₗ³/Σᵢnₗdₗ²

d₄₃=Σᵢnₗdₗ⁴/Σᵢnₗdₗ³

where nₗ is the number of droplets of diameter dₗ.

States of droplet flocculation were assessed qualitatively by examining emulsions by light microscopy using the Normarski differential interference contrast technique. Creaming stability was assessed visually by determining the time-dependent thicknesses of cream and serum layers in emulsions stored quiescently at 22° C. In the Examples, cream separation (%) is the height of the cream layer expressed as a percentage of the total height of the serum layer+the cream layer.

### EXAMPLE 1

An aqueous buffer was prepared using double-distilled water, citric acid (50 wt %), sodium benzoate (25 wt %) and sodium azide (0.01 wt %) as an antimicrobial agent. Samples of protein and protein/polysaccharide conjugates in buffer solution were prepared by slowly adding protein or conjugate to quantities of the buffer solution at ca. 22° C. with gentle stirring. The amount of protein or conjugate added was sufficient to provide the protein or conjugate at 1 wt % level in subsequent emulsions. The pHs of the resulting sample solutions were adjusted by adding a few drops of 1M NaOH. Subsequently reported pH values refer to the pH of the sample solutions before emulsification.

n-tetradecane oil-in-water samples as identified in Table 1 were prepared by mixing 80 vol % buffered protein or protein/polysaccharide conjugate with 20 vol % oil at room temperature and homogenising it using a laboratory scale jet homogeniser operating at a pressure of 300 bar. The resultant emulsions were stored at room temperature.

TABLE 1

| | | | Weight | | |
|---|---|---|---|---|---|
| | | | ratio of | | |
| | | Poly- | protein to | | |
| Sample | Pro- | sac- | polysac- | | |
| No | tein | charide | charide | pH | Comments |
| 1* | WP | — | — | 6.8 | |
| 2* | WP | — | — | 6.8 | Heat treated |
| 3* | WP | DX245 | 1:3 | 6.8 | Mixture - no heat treatment |
| 4 | WP | DX245 | 1:3 | 6.8 | Conjugate |
| 5* | WP | GA | 1:3 | 6.8 | Mixture - no heat treatment |
| 6 | WP | GA | 1:3 | 6.8 | Conjugate |
| 7* | SC | — | — | 6.8 | |
| 8* | SC | — | — | 6.8 | Heat treated |
| 9* | SC | DX245 | 1:3 | 6.8 | Mixture - no heat treatment |
| 10* | SC | DX245 | 1:3 | 6.8 | Conjugate |
| 11* | SC | GA | 1:3 | 6.8 | Mixture - no heat treatment |
| 12* | SC | GA | 1:3 | 6.8 | Conjugate |

*Comparative Samples.

The d₄₃ droplet sizes of Samples 1 to 12 were measured after 0.5 hour and after 30 days. The results are shown below in Table 2.

The cream separation was measured at 16 days, 70 days and 103 days. The results are given in Table 3.

As can be seen from Tables 2 and 3, the WP/DX conjugate according to the invention forms a very good, fine droplet, stable emulsion.

TABLE 2

| | d₄₃ droplet sizes | d₄₃ droplet sizes after |
|---|---|---|
| Sample | after 0.5 hour (μm) | 30 days (μm) |
| 1* | 0.6 | 0.8 |
| 2* | 0.7 | 1 |
| 3* | 0.65 | 1.7 |
| 4 | 0.35 | 1 |
| 5* | 2.3 | 6.5 |
| 6 | 0.75 | 1 |
| 7* | 1 | 1 |
| 8* | 3 | 3.5 |
| 9* | 0.9 | 1 |
| 10* | 1 | 1 |
| 11* | 7.5 | 4 |
| 12* | 15 | 17 |

*Comparative Samples.

TABLE 3

| | Cream Separation | Cream Separation | Cream Separation |
|---|---|---|---|
| Sample | (%) after 16 days | (%) after 70 days | (%) after 103 days |
| 1* | 5 | 36 | 54 |
| 2* | 1 | 21 | 42 |
| 3* | 1 | 9 | 14 |
| 4 | 1 | 2 | 5 |
| 5* | 10 | 20 | 22 |
| 6 | 1 | 3 | 6 |
| 7* | 4 | 38 | 56 |
| 8* | 1 | 25 | 46 |
| 9* | 1 | 10 | 18 |
| 10* | 1 | 3 | 7 |
| 11* | 39 | 56 | 60 |
| 12* | 1 | 15 | 35 |

*Comparative Samples.

### EXAMPLE 2

Example 1 was repeated using the proteins and protein/polysaccharide conjugates identified in Table 4 and using MCT oil to form the emulsions.

The d₄₃ droplet sizes of Samples 13 to 28 were measured after 12 hours and after 25 days. The results are shown below in Table 5.

As can be seen from Table 5, the WP/DX conjugates according to the invention form very good, fine droplet, stable emulsions at both pH 7 and at pH3.7. In contrast, the PP/DX conjugates exhibit a significantly poorer emulsifying effect.

TABLE 4

| | | | Weight ratio of | | |
|---|---|---|---|---|---|
| Sample | | Poly- | protein to | | |
| No | Protein | saccharide | polysaccharide | pH | Comments |
| 13* | WP | — | — | 7 | |
| 14* | WP | — | — | 3.7 | |
| 15 | WP | DX70 | 1:3 | 7 | Conjugate |
| 16 | WP | DX245 | 1:3 | 7 | Conjugate |
| 17 | WP | DX500 | 1:3 | 7 | Conjugate |
| 18 | WP | DX70 | 1:3 | 3.7 | Conjugate |
| 19 | WP | DX245 | 1:3 | 3.7 | Conjugate |
| 20 | WP | DX500 | 1:3 | 3.7 | Conjugate |
| 21* | PP | — | — | 7 | |
| 22* | PP | — | — | 3.7 | |
| 23* | PP | DX70 | 1:3 | 7 | Conjugate |
| 24* | PP | DX245 | 1:3 | 7 | Conjugate |
| 25* | PP | DX500 | 1:3 | 7 | Conjugate |
| 26* | PP | DX70 | 1:3 | 3.7 | Conjugate |
| 27* | PP | DX245 | 1:3 | 3.7 | Conjugate |
| 28* | PP | DX500 | 1:3 | 3.7 | Conjugate |

*Comparative samples.

TABLE 5

| Sample | d₄₃ droplet sizes | d₄₃ droplet sizes |
|---|---|---|
| No | after 12 hours (μm) | after 25 days (μm) |
| 13* | 0.7 | 0.7 |
| 14* | 7 | 17 |
| 15 | 0.43 | 0.42 |
| 16 | 0.3 | 0.28 |
| 17 | 0.35 | 0.33 |
| 18 | 0.35 | 0.48 |
| 19 | 0.33 | 0.33 |
| 20 | 0.35 | 0.35 |
| 21* | 15 | 14 |
| 22* | 160 | 180 |
| 23* | 12 | 10 |
| 24* | 4.5 | 4 |
| 25* | 3.7 | 3 |
| 26* | 24 | 19 |
| 27* | 21 | 13 |
| 28* | 40 | 19 |

*Comparative samples

### EXAMPLE 3

An aqueous buffer was prepared using double-distilled water, citric acid (50 wt %), sodium benzoate (25 wt %) and potassium metabisulphite (15 wt %). Samples of protein and protein/polysaccharide conjugates in buffer solution were prepared by slowly adding protein or conjugate to quantities of the buffer solution at ca. 22° C. with gentle stirring. The pH's of the resulting sample solutions were adjusted to 3.2 by adding a few drops of 1M NaOH. The ionic strength of the emulsions were 0.2M.

Using MCT oil, a number of emulsions stabilised using different amounts of WP were prepared by mixing 80 vol % buffered protein or protein/polysaccharide conjugate with 20 vol % oil at room temperature and homogenising it using a laboratory scale jet homogeniser operating at a pressure of 350 bar.

The d₄₃ droplet sizes varied from about 4.5 μm at 0.2 wt % WP to about 1 μm at 1.5 wt % WP. At 0.8 wt % WP, the d₄₃ droplet size was about 3 μm. Accordingly, subsequent emulsions were prepared to have a protein content of 0.8 wt %. For example, 3.2 wt % of a 1:3 protein/polysaccharide conjugate nominally has a protein content of 0.8 wt %.

Emulsion samples of GA (3.2 wt %), WP (0.8 wt %) and WP/dextran conjugates (3.2 wt %) with MCT oil (20 vol %) were made up as described above and as identified in Table 6 below. The samples had a pH of 3.2 and an ionic strength of 0.2M.

The d₄₃ droplet sizes of Samples 29 to 39 were measured after 12 hours and 31 days. The results are given in Table 6.

TABLE 6

| | | | Weight | | |
|---|---|---|---|---|---|
| | | | ratio of | | |
| | | Poly- | protein to | d₄₃ droplet | d₄₃ droplet |
| Sample | | sac- | polysac- | sizes after 12 | sizes after 31 |
| No | Protein | charide | charide | hours (μm) | days (μm) |
| 29* | GA | — | | 2.5 | 3 |
| 30* | WP | — | | 3.5 | 14 |
| 31 | WP | DX | | 0.5 | 0.5 |
| 32 | WP | DX70 | 1:1 | 2.2 | 3.2 |
| 33 | WP | DX70 | 1:3 | 0.3 | 0.3 |
| 34 | WP | DX70 | 1:5 | 0.25 | 0.3 |
| 35 | WP | DX70 | 1:8 | 0.3 | 0.9 |
| 36 | WP | DX500 | 1:1 | 2.2 | 3.2 |
| 37 | WP | DX500 | 1:3 | 0.3 | 0.3 |
| 38 | WP | DX500 | 1:5 | 0.25 | 0.3 |
| 39 | WP | DX500 | 1:8 | 0.25 | 1 |

*Comparative samples.

As can be seen from Table 6, the WP/DX conjugates according to the invention form very good, fine droplet, stable emulsions, especially when the protein to polysaccharide weight ratio is <1:1 and is >1:8. Thus, the preferred protein to polysaccharide weight ratios are in the range 1:3 to 1:5. It should also be noted that the conjugates, especially the preferred conjugates, perform significantly better than either GA or WP as emulsifiers.

### EXAMPLE 4

Emulsions as identified in Table 7 were made up as described in Example 4. The WP/DX70 conjugate had a protein to polysaccharide weight ratio of 1:3.

TABLE 7

| | | | d₄₃ droplet | Cream |
|---|---|---|---|---|
| Sample | Protein or | | sizes after 24 | Separation (%) |
| No | Conjugate | Oil | hours (μm) | after 90 days |
| 40* | GA | MCT | 2.5 | 5 |
| 41* | WP | MCT | 3.5 | 6 |
| 42 | WP/DX70 | MCT | 0.5 | 1 |
| 43* | GA | Silicone | 4 | 12 |
| 44* | WP | Silicone | 5.5 | 26 |
| 45 | WP/DX70 | Silicone | 1.5 | 2 |
| 46* | GA | Orange | 4.2 | 21 |
| 47* | WP | Orange | 13.5 | 42 |
| 48 | WP/DX70 | Orange | 2 | 3 |
| 49* | GA | n-tetradecane | 6 | 21 |
| 50* | WP | n-tetradecane | 10 | 36 |
| 51 | WPDX70 | n-tetradecane | 0.5 | 1 |

*Comparative Samples.

As can be seen from Table 7, the WP/DX conjugate according to the invention forms very good, fine droplet, stable emulsions using a range of oils. In contrast, the GA and WP emulsifiers perform significantly worse than the conjugate according to the invention.

### EXAMPLE 5

Example 3 was repeated for WP (1 wt %), WP/maltodextrin conjugates (1 wt %), SP (1 wt %) and SP/maltodextrin conjugates (1 wt %) at pH 3.2 and MCT oil as identified in

TABLE 8

| | | | d₄₃ | d₄₃ | | |
|---|---|---|---|---|---|---|
| | | | droplet | droplet | | |
| | | | sizes | sizes | Cream | Cream |
| | | Poly- | after | after | Separation | Separation |
| Sample | Pro- | sac- | 24 hours | 30 days | (%) after | (%) after |
| No | tein | charide | (μm) | (μm) | 24 hours | 30 days |
| 52* | WP | — | 4 | 8 | 8 | 14 |
| 53 | WP | MD | 2 | 2 | 5 | 12 |
| 54* | SP | — | 22 | 42 | 8 | 14 |
| 55* | SP | MD | 40 | 97 | 28 | 37 |

*Comparative samples.

Table 8. The maltodextrin had a DE of 2. The conjugates had a protein to polysaccharide weight ratio of 1:3.

As can be seen from Table 8, the WP/MD conjugate according to the invention forms a good, fine droplet, stable emulsion.

### EXAMPLE 6

WP/MD conjugates (DE=2, av Mw=280 kDa; DE=19, av Mw=8.7 kDa; DE47, av Mw=2 kDa) (2.5 wt %) were added to an aqueous citric buffer of pH 3 and dissolved immediately.

WP, both untreated and heat-treated, (2 wt %) were added to an aqueous citric buffer of pH 3 with stirring and took about 2 hours to dissolve.

All of the resulting solutions were clear.

The pH of the solutions was adjusted to between pHs of 3 and 5.5. The WP solutions became turbid at pH 4.7 and, therefore, have limited value in acidic emulsions. In contrast, the WP/MD conjugates remained clear throughout the whole pH range and, therefore, have clear utility in acidic environments.

### EXAMPLE 7

WP, heat-treated WP (HWP) and WP/MD conjugates were used to make emulsions as previously described. The protein and conjugates were added at 2 wt %. Orange oil (20 vol %) was used to make the emulsions. The samples are identified in Table 9 together with the initial d₄₃ droplet sizes achieved.

As can be seen from Table 9, the WP/MD conjugates according to the invention form good, fine droplet, stable emulsions. The conjugates with higher DE MD's created emulsions with smaller initial d₄₃ droplet size than the low DE MD, especially the middle range DE MD which is preferred.

### EXAMPLE 8

WP/MD19 emulsions (containing 2.5 wt % conjugate) in protein to polysaccharide weight ratios of 2:1 (Samples 73 to 76) and 1:1 (Samples 77 to 80) were mixed with a colourant solution in a 70:30 volume ratio to form coloured solutions at various pH's. The emulsions were made using 20 vol % of a 1:1 orange oil/ester gum oil mixture. The colourant solution contained the ingredients shown in Table 10.

After a storage period of 192 hours, the d₄₃ droplet size of the resultant coloured solutions was determined and they are listed in Table 11.

TABLE 9

| | | | Weight ratio of | Initial d₄₃ |
|---|---|---|---|---|
| Sample | | Poly- | protein to | droplet sizes |
| No | Protein | saccharide | polysaccharide | (μm) |
| 56* | WP | — | | 3.9 |
| 57* | HWP | — | | 6.1 |
| 58 | WP | MD2 | 1:1 | 5.5 |
| 59 | WP | MD2 | 1:2 | 7 |
| 60 | WP | MD2 | 1:3 | 7.8 |
| 61 | WP | MD2 | 1:4 | 7.3 |
| 62 | WP | MD2 | 1:5 | 6.5 |
| 63 | WP | MD19 | 1:1 | 1.6 |
| 64 | WP | MD19 | 1:2 | 2.1 |
| 65 | WP | MD19 | 1:3 | 3 |
| 66 | WP | MD19 | 1:4 | 2.4 |
| 67 | WP | MD19 | 1:5 | 4.1 |
| 68 | WP | MD47 | 1:1 | 2.4 |
| 69 | WP | MD47 | 1:2 | 2.2 |
| 70 | WP | MD47 | 1:3 | 4.3 |
| 71 | WP | MD47 | 1:4 | 5 |
| 72 | WP | MD47 | 1:5 | 3.9 |

*Comparative samples.

TABLE 10

| Colouring Solution Ingredient | Quantity (g) |
|---|---|
| Warm water | 46.2 |
| Ponceau 4R granular | 0.25 |
| Sunset yellow FCF granular | 2.75 |
| 25% sodium benzoate | 0.25 |
| 50% citric acid | 0.28 |

TABLE 11

| | | Initial d₄₃ | | Initial d₄₃ |
|---|---|---|---|---|
| pH of | Sample | droplet | Sample | droplet |
| solution | No | sizes (μm) | No | sizes (μm) |
| 3.5 | 73 | 42 | 77 | 2 |
| 4.0 | 74 | 14 | 78 | 1 |
| 4.5 | 75 | <1 | 79 | <1 |
| 5.0 | 76 | <1 | 80 | <1 |

It will be noted that, at lower pHs, the 1:1 protein to polysaccharide conjugate (Samples 77 to 80) performed significantly better than the 2:1 conjugate (Samples 73 to 77). Indeed, the latter, at pH 3.5, flocculated significantly and produced precipitate only 24 hours after the coloured solution was made owing to the presence of free protein, which reacts with the azo-based colouring ingredients.

### EXAMPLE 9

Example 8 was repeated using WP, GA and WP/MD19 conjugates in various protein to polysaccharide weight ratios.

The method of preparation of the WD/MD19 conjugates used in this Example was varied by increasing the temperature to 85° C. and stirring the mixture every 30 minutes during the 2 hour conjugation period.

The emulsions were mixed with the colourant solution in the ratio of 7.2 g to 2.8 g.

The amount of protein or conjugate added prior to emulsification was 2.5 wt % except that, in the case of GA, a second sample (Sample 82) at 30 wt % was also made.

After a storage period of 13 days, the d₄₃ droplet size of the emulsions and of the resultant coloured emulsions was determined and they are listed in Table 12.

The coloured solution containing just the WP phase separated and precipitated.

TABLE 12

| | | | Weight ratio of | Initial d₄₃ | Initial d₄₃ |
|---|---|---|---|---|---|
| Sample | | Poly- | protein to | droplet | droplet |
| No | Protein | saccharide | polysaccharide | sizes (μm) | sizes (μm) |
| 81* | GA | — | — | 3.8 | 3.8 |
| 82* | GA | — | — | 0.65 | 0.68 |
| 83* | WP | — | — | 6.25 | 32.48 |
| 84 | WP | MD19 | 1:1 | 0.58 | 1.02 |
| 85 | WP | MD19 | 1:2 | 0.55 | 0.75 |
| 86 | WP | MD19 | 1:3 | 0.77 | 0.97 |
| 87 | WP | MD19 | 1:4 | 0.85 | 1.41 |
| 88 | WP | MD19 | 1:5 | 0.96 | 1.30 |

*Comparative Samples

As can be seen from Table 12, the WP/MD conjugates according to the invention form good, fine droplet, stable emulsions. It will be noted that, to get equivalent performance from the known emulsifier GA, up to 10+ times the amount of GA had to be added (see Sample 82). A comparison of Samples 63 to 67 in Table 9, Example 7 with Samples 84 to 88 in Table 12 above demonstrates that an increase of incubation temperature from 80° C. to 85° C. and stirring the protein/maltodextrin mixture during the dry heating step increases the performance of the final conjugate significantly.

### EXAMPLE 10

Coloured emulsions made from conjugates of various ratios of WP/MD19 (2.5 wt %), WP (2.5 wt %) and GA (30 wt %) were prepared as described in Example 9 and were then made up into a sugar syrup. The sugar syrup was based on the following recipe:
50 ml water
1 ml sodium benzoate (25% solution)
10 ml citric acid (50% solution)
350 ml sugar syrup (67% solution)
3 g 20% oil-in-water coloured emulsion.

The resultant syrup was made up to 500 ml with water.

One part of the sugar syrup was then diluted with 5 parts of carbonated water to form a soft drink formulation.

All coloured emulsions stabilised by conjugates of WP/MD19 (ratio 1:2 and 1:3) were stable upon dilution at pH 3.2, and no flocculation/precipitation was observed over a storage period of 10 days. The WP-stabilised coloured emulsions clearly showed phase separation upon dilution, i.e. an upper clear phase and a coloured precipitate lower phase. On comparison, the diluted conjugate-stabilised emulsions are similar in overall appearance (by eye) to the GA-stabilised emulsions (in which the level of GA is 10+ times higher than the level of the conjugates).

This shows that glycoprotein conjugates made from whey protein and maltodextrin by controlled dry heating are able to give stable emulsions and their corresponding coloured dilutions as well as final beverages at much lower use levels as compared to the traditionally known emulsifier/stabiliser systems such as gum Arabic. The benefit of the conjugates is that their properties are more controlled and predictable as compared with gum Arabic, which is sourced from Acacia trees which are subject to varying climatic conditions and climate changes which, in turn, influence the composition and, therefore, the emulsifying properties of the gum Arabic.

1. An emulsifier comprising a protein/polysaccharide conjugate derived from whey protein and a non-ionic polysaccharide.

2. An emulsifier comprising a protein/polysaccharide conjugate derived from whey protein and a polysaccharide component selected from the group consisting of a dextran or a maltodextrin or a polysaccharide group contained in a naturally occurring gum, preferably gum Arabic, or mixtures thereof.

3. An emulsifier according to claim 1 in which the weight ratio of protein to polysaccharide in the conjugate is in the range 0.9:1 to 1:10.

4. An emulsifier according to claim 3 in which the protein to polysaccharide weight ratio is at least 1:1 and, more especially, is at least 1:2.

5. An emulsifier according to claim 3 in which the protein to polysaccharide weight ratio is not more than 1:8 and, more especially, is not more than 1:6.

6. An emulsifier according to claim 1 in which the whey protein is lactose-free whey protein; more especially the whey protein is a lactose-free whey protein isolate.

7. An emulsifier according to claim 1 in which the non-ionic polysaccharide is a dextran or a maltodextrin or a polysaccharide contained in a naturally occurring gum, preferably gum Arabic.

8. An emulsifier according to claim 1 in which the polysaccharide is a maltodextrin.

9. An emulsifier according to claim 7 wherein the maltodextrin is selected to have a dextrose equivalent of between 5 and 50.

10. An emulsifier according to claim 9 in which the maltodextrin is selected to have a dextrose equivalent of at least 10 and, more especially of at least 12.

11. An emulsifier according to claim 8 in which the maltodextrin is selected to have a dextrose equivalent of less than 40, more especially of less than 30.

12. Use of an emulsifier according to claim 1 in an emulsion.

13. An oil-in-water emulsion comprising water, an organoleptic oil and an emulsifier according to claim 1.

14. An emulsion according to claim 13 comprising 70 to 95 wt % of an aqueous phase and 5 to 30 wt % of a dispersed phase.

15. An emulsion according to claim 13 comprising 0.1 wt % to 10 wt % emulsifier.

16. An emulsion according to claim 13 comprising at least 1 wt % of emulsifier.

17. An emulsion according to claim 13 comprising not more than 7 wt % of emulsifier, more especially, not more than 5 wt % emulsifier.

18. An emulsion according to claim 13 which has a pH of not greater than 7.

19. An emulsion according to claim 13 which is acidic.

20. An emulsion according to claim 13 which has a pH in the range 2 to 6, more preferably in the range 3 to 6.

21. A beverage comprising a diluted emulsion according to claim 13.

22. A beverage according to claim 21 in which the beverage contains at least about 1 part of emulsion in 100 parts of beverage and, more preferably, contains at least about 1 part of emulsion in 250 parts of beverage and, more especially, contains at least about 1 part of emulsion in 400 parts of beverage.

23. A beverage according to claim 21 in which the beverage contains not more than about 1 part of emulsion in 1000 parts of beverage and, more preferably, contains not more than about 1 part of emulsion in 750 parts of beverage and, more especially, contains not more than about 1 part of emulsion in 600 parts of beverage.

24. A beverage according to claim 21 in which the beverage contains about 1 part of emulsion in 500 parts of beverage.

25. A beverage according to claim 21 in which the diluent comprises water.

26. A process of making an emulsifier comprising a protein/polysaccharide conjugate derived from whey protein and a non-ionic polysaccharide, the process comprising intimately mixing the whey protein and the polysaccharide, exposing the mixture to dry heat under controlled humidity conditions for a period sufficient to allow at least a major proportion of the protein's amine groups to form covalent linkages with the polysaccharide.
